(19) United States
(12) Patent Application Publication
(10) Pub. No.: US 2017/0278438 A1
(43) Pub. Date: Sep. 28, 2017

(54) SIMULATING NEON LAMP

(71) Applicant: Enhance Neon Technologies Shanghai Co., Ltd, Shanghai (CN)

(72) Inventor: Mingchu Kuo, Shanghai (CN)

(73) Assignee: Enhance Neon Technologies Shanghai Co., Ltd

(21) Appl. No.: 15/458,972

(22) Filed: Mar. 15, 2017

Related U.S. Application Data
(63) Continuation of application No. PCT/CN2016/080951, filed on May 4, 2016.

(30) Foreign Application Priority Data
Mar. 25, 2016 (CN) 201620238257.5

(51) Int. Cl. G09F 13/04; G09F 13/08; F21S 10/00; F21V 19/00; F21V 3/00

(52) U.S. Cl. CPC G09F 13/0413; F21V 19/003; F21V 3/00; F21S 10/00; G09F 13/08; F21Y 2115/10

(57) ABSTRACT

A simulating neon lamp is disclosed, which comprises a bottom base (10), a back, light source (20), a display assembly (30) and a cover plate (40); wherein the bottom case (10) is opaque and hollow and has an opening facing upward; the back light source (20) is mounted in the bottom case (10); the display assembly (30) is translucent and fixed onto the bottom case (10) to close the opening; the display assembly (30) comprises a first display panel (31); the sectional width of the first display panel (31) is less than that of the bottom case (10), and an upper surface of a connection where the first display panel (31) is connected with the bottom case (10) is not higher than a top end of the bottom case (10): the cover plate (40) is opaque and covers the connection where the first display panel (31) is connected with the bottom case (10) so as to shield the light penetrating from a gap of the connection where the first display panel (31) is connected with the bottom case (10). The present invention has such advantages as safety, energy-conservation and low cost, excellent effect simulating a neon lamp and so on.

### CROSS-REFERENCE TO RELATED APPLICATIONS

This application is a continuation of International Patent Application No. PCT/CN2016/080951 with a filing date, of May 4, 2016, designating the United States, now pending, and further claims priority to Chinese Patent Application No. 201620238257.5 with a filing date of Mar. 25, 2016. The content of the aforementioned application, including any intervening amendments thereto, are incorporated herein by reference.

### TECHNICAL FIELD

The present invention relates to a lamp, especially a simulating neon lamp.

### BACKGROUND OF THE PRESENT INVENTION

Colorful neon lamps are widely used in the advertising industry. However, they have such disadvantages as high power consumption, low safety, poor durability, containing contaminants, etc. Current simulating neon lamps, which use LEDs as their light sources, mostly have planar surfaces that could not offer a three-dimensional effect like traditional neon lamps. Those simulating neon lamps with convex surfaces are easily subjected to light diffuse reflection, it is difficult for their light sources to concentrate and their lighting effect is relatively poor, thus they could not simulate traditional neon lamps in an effective and vivid way.

### SUMMARY OF PRESENT INVENTION

For the purpose of overcoming the prior art drawbacks, the present invention provides a simulating neon lamp, which in use is capable of simulating the light decoration effect of a neon light, and which meanwhile has such benefits as safety and energy conservation.

In order to achieve the above-mentioned objects, the present invention provides a simulating neon lamp, which comprises: a bottom case, a back light source, a display assembly and a cover plate, wherein the bottom case is opaque/non-transparent and hollow and has an opening facing upward; the back light source is mounted in the bottom case; the display assembly is translucent and fixed onto the bottom case to close the opening; the display assembly comprises a first display panel; the sectional width of the first display panel is less than that of the bottom case, and the upper surface of a connection where the first display panel is connected with the bottom case is not higher than the top end of the bottom case; the cover plate is opaque, covering the connection where the first display panel is connected with the bottom case so as to shield the light penetrating from a gap of the connection where the first display panel is connected with the bottom case.

Furthermore, the present invention provides a simulating neon lamp which could be characterized in that the top end of the bottom case is provided with an insertion groove in which the first display panel is fixed.

Furthermore, the present invention provides a simulating neon lamp which could be characterized in that the first display panel is a lamp strip, and the cover plate is fixed onto an edge of the lamp strip and the top end of the bottom case.

Furthermore, the present invention provides a simulating neon lamp which could be characterized in that the lamp strip is a convex lamp strip and/or a planar lamp strip, wherein the convex lamp strip has a Ω-shaped section.

Furthermore, the present invention provides, a simulating neon lamp which could be characterized in that the display assembly also comprises a second display panel.

Furthermore, the present invention provides a simulating neon lamp which could be characterized in that the sectional width of the second display panel is less than that of the bottom case, and the upper surface of a connection with the second display panel is connected with the bottom base is not higher than the top end of the bottom case; the cover plate also covers the connection where the second display panel is connected with the bottom case, so as to shield, the light penetrating from a gap of the connection where the first display panel is connected with the bottom case.

Furthermore, the present invention provides a simulating neon lamp which could be characterized in that the second display panel is a printed sheet.

Moreover, the present invention provides a simulating neon lamp which could be characterized in that the cover plate is black in color, the bottom case is black in color.

Moreover, the present invention provides a simulating neon lamp which could be characterized in that the back light source comprises several LED lamp beads and a PCB substrate: the LED lamp beads are mounted on the PCB substrate; the PCB substrate is mounted within the bottom case.

Furthermore, the present invention provides a simulating neon lamp which could be characterized in that the lamp further comprises a bracket disposed below the bottom case.

The present invention provides the following beneficial effects: the present invention provides a simulating neon lamp, wherein the back light source is mounted within a opaque/non-transparent bottom base, and the sectional width of the translucent/semi-transparent lamp strip is less than that of the bottom base, and the lamp strip is fixed into the insertion groove of the bottom base via its edge whose upper surface is not higher than the top end of the bottom case, the opaque cover plate is covering onto the edge of the lamp strip and the top end of the bottom base so as to shield the light penetrating from the gap of the connection where the lamp strip is connected with the bottom base, so that the light from the back light source is emitted in a more concentrative way from the central position of the lamp strip to make the penetrating light brighter and clearer, so as to simulate the neon light in a more effective and vivid way.

It is possible to use printed sheets on which various patterns could be printed. They could be combined by a user according to various design requirements so as to meet different decoration conditions. In addition, the bottom base is hollow with an upward-facing opening, so that the lateral wall is integrated with the bottom plate to reduce the manufacturing cost. The present invention has such advantages as safety, energy-conservation and low cost, good simulative effect for a neon lamp and so on.

### DESCRIPTION OF THE DRAWINGS

FIG. 1 is an integral three-dimensional exploded view of a simulating neon lamp according to the first embodiment;

FIG. 2 is a partial three-dimensional exploded view of a simulating neon lamp according to the first embodiment;

FIG. 3 is a longitudinal semi-sectional view of a single section of a simulating neon lamp according to the first embodiment;

FIG. 4 is an integral three-dimensional exploded view of a simulating neon lamp according to the second embodiment.

### DETAILED DESCRIPTION OF PREFERRED EMBODIMENTS

Hereinafter, specific embodiments of the present invention will be described by reference to the drawings.

### The First Embodiment

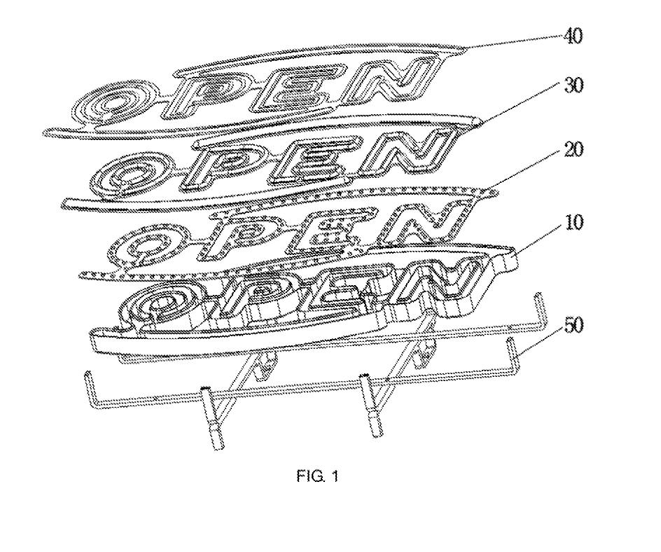

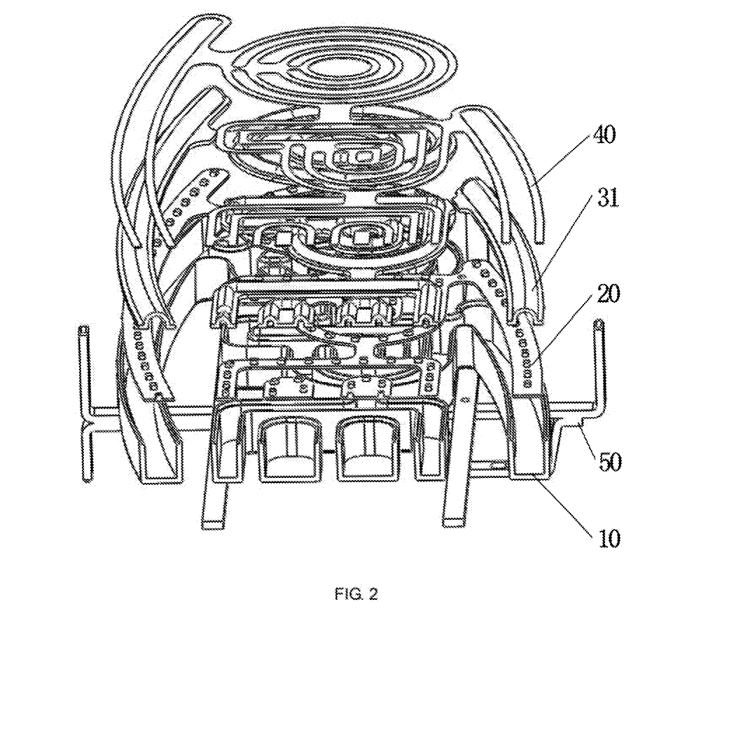

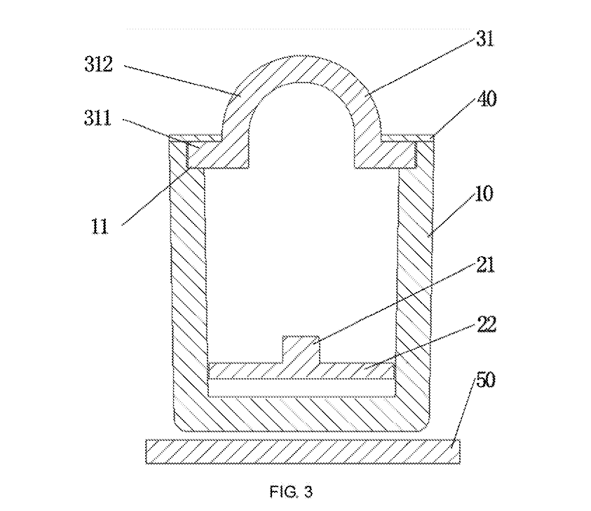

As shown in FIGS. 1, 2 and 3, this embodiment relates to a simulating neon lamp which comprises: a bottom case 10, a back light source 20, a display assembly 30, a cover plate 40 and a bracket 50, wherein the display assembly 30 comprises a first display panel 31. In the embodiment, the first display panel 31 is a convex lamp strip.

The bottom case 10 is hollow, and has an opening facing, upward, which has a shape consistent with the convex lamp strip 31, i.e. the shape designed for the simulating neon lamp. The top end of the bottom base 10 is provided with an insertion groove 11 for fixing the convex lamp strip 31. The bottom case 10 is opaque and black in color so as to simulate the appearance of a neon lamp more vividly. The material of the bottom base 10 is ABS or any other opaque material.

The back light source 20 comprises several LED tamp beads 21 and a PCB substrate 22, which is mounted within the bottom base 10. The LED lamp beads are mounted on the PCB substrate, and the PCB substrate is fixed and mounted within the bottom base 10 via threaded connection and so on, so as to form a back light source 20 in consistent shape with the convex lamp strip 31, for the purpose of providing a light source for the simulating neon lamp. The coloring of the light source could be customized according to design requirements.

The convex lamp strip 31 is translucent, and has a Ω-shaped section with flat edges 311 and an arc-shaped projection 312 therebetween, so as to simulate a neon lamp tube more vividly. The sectional width of the convex lamp strip 31 is less than that of the bottom base 10, and the convex lamp strip 31 is fixed in the insertion groove 11 via the edges 311 so as to close the opening of the groove and shield the back light source 20. The upper surface of the edge 311 is not higher than the top end of the bottom base 10, so that the light irradiating from the back light source 20 cannot be emitted from the lateral side of the lamp strip 31, but instead, only from the surface thereof.

The convex lamp strip 31 is fixed to the bottom base 10 by such connecting manners as adhering, threading and so on. The convex lamp strip 31 is produced by the suction-molding or injection-molding method, so as to make it possible to produce various shapes and colors. The material of the convex, lamp strip 31 is PMMA or any other translucent material.

The cover plate 40 is opaque, covering the connection where the convex lamp strip 31 is connected with the bottom base 10, so as to block the light penetrating from the gap of, the connection where the convex lamp strip 31 is connected with the bottom base 10. As such, the light irradiating from the back light source 20 could be emitted from the arc-shaped projection 312 in a more concentrated way. The cover plate 40 is black in color, which simulates the appearance and effect of a neon lamp more vividly. The material of the cover plate 40 is PVC or, any other opaque material.

The bracket 50 is disposed under the bottom base 10 for fixing the simulating neon lamp, so as to integrally fasten the lamp at the targeted use position. In this embodiment, the bracket 50 is an iron-made bracket.

In this embodiment, the convex lamp strip 31 could be planar shaped, or could have any other shape.

### The Second Embodiment

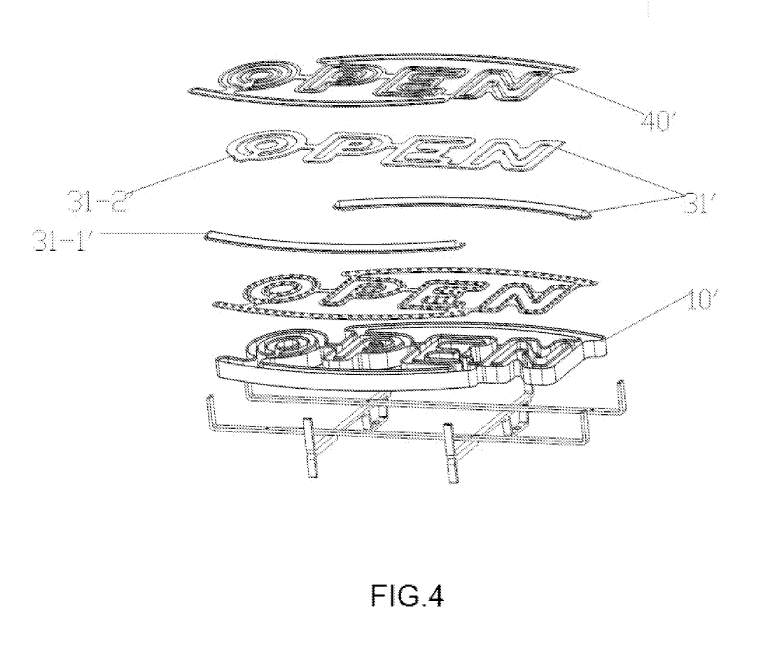

As shown in FIG. 4, this embodiment provides a simulating neon lamp whose structure is substantially the same as, that of the first embodiment, with the only difference in regard to the first display panel 31′. In this embodiment, the first display panel 31′ consists of the combination of a convex lamp strip 31-1′ and a planar lamp strip 31-2′, so as to achieve cooperatively the designed shape of the simulating neon lamp.

Wherein, the convex lamp strip 31-1′ is similar to that of the first embodiment. The section of the planar lamp strip 31-2′ has a flat shape, and its width is less than the sectional width of the bottom base. The edge of the planar lamp strip is not higher than the top end of the bottom base. The cover plate 40′ is fixed to the edge of the planar lamp strip 31-2′ and the top end of the bottom base 10′, so as to shield the light penetrating from the gap of the connection where the planar lamp strip 31-2′ is connected to the bottom case 10′, so that the light is concentrated and penetrated from the center of the planar lamp strip 31-2′ to finally achieve the effect of simulating the neon lamp,

In this embodiment, the display assembly could further comprise a second display panel which could be a printed sheet. The printed sheet is a translucent sheet material whose section is similar to that of the planar lamp strip and exhibits a flat shape. Below the printed sheet there are disposed the back light source and the bottom case, wherein the sectional width of the printed sheet is less than that of the bottom base, and wherein the upper surface of the connection where the printed sheet is connected with the bottom base is not higher than the top end of the bottom case. The cover plate covers the connection where the printed sheet is connected with the bottom case, so as to block the light penetrating from the gap of the connection where the printed sheet is connected, with the bottom case. The printed sheet could be of any shape, with various patterns and colors printed on its surface, so as to enrich the decoration. The printed sheet could be used in combination with the first display panel.

I claim:

1. A simulating neon lamp comprises:
a bottom base (10), a back light source (20), a display assembly (30) and a cover plate (40); wherein
the bottom case (10) is opaque, and hollow and as an opening facing upward;
the back light source (20) is mounted within the bottom base (10);
the display assembly (30) is translucent and fixed onto the bottom base (10) to dose the opening;
the display assembly (30) comprises a first display panel (31);
the sectional width of the first display panel (31) is less than that of the bottom base (10), and an upper surface of a connection where the first display panel (31) is connected with the bottom base (10) is not higher than a top end of the bottom case (10);
the cover plate (40) is opaque and covers the connection where the first display panel (31) is connected with the bottom case (10), so as to block the light penetrating from a gap of the connection where the first display panel (31) is connected with the bottom case (10).

2. The simulating neon lamp according to claim 1, wherein
the top end of the bottom base (10) has an insertion groove (11) in which the first display panel (31) is fixed.

3. The simulating neon lamp according to claim 1, wherein
the first display panel (31) is a lamp strip, and the cover plate (40) is fixed onto an edge of the lamp strip and the top end of the bottom base (10).

4. The simulating neon lamp according to claim 3, wherein
the lamp strip is a convex lamp strip and/or a planar lamp strip, wherein the convex lamp strip has a “Ω”-shaped section.

5. The simulating neon lamp according to claim 1, wherein
the display assembly (30) is further provided with a second display panel.

6. The simulating neon lamp according to claim 5, wherein
the sectional width of the second display panel is less than that of the bottom base (10), and an upper surface of a connection where the second display panel is connected with, the bottom base (10) is not higher than the top end of the bottom case (10);
the cover plate (10) further covers the connection where the second display panel is connected with the bottom case (10), so as to block the light penetrating from a gap of the connection where the second display panel is connected with the bottom case (10).

7. The simulating neon lamp according to claim 5, wherein
the second display panel is a printed sheet.

8. The simulating neon lamp according to claim 1, wherein
the cover plate (40) is black in color;
the bottom base (10) is black in color.

9. The simulating neon lamp according to claim 1, wherein the back light source (20) comprises several LED lamp beads (21) and a PCB substrate (22), wherein the LED lamp beads (21) are mounted on the PCB substrate (22), and the PCB substrate (22) is mounted within the bottom case (10).

10. The simulating neon lamp according to clam 1, wherein
the simulating neon lamp further comprises a bracket (50) disposed below the bottom base (10).
